(19) United States
(12) Patent Application Publication
(10) Pub. No.: US 2023/0101000 A1
(43) Pub. Date: Mar. 30, 2023

(54) INPUT DEVICE HOLDER ASSEMBLIES

(71) Applicant: Hewlett-Packard Development Company, L.P., Spring, TX (US)

(72) Inventors: Cheng-Han Tsai, Taipei City (TW); Wen-Hua Ni, Taipei City (TW); Tai-Hsiang Chen, Taipei City (TW)

(21) Appl. No.: 17/911,378

(22) PCT Filed: Mar. 27, 2020
(86) PCT No.: PCT/US2020/025297

§ 371 Date: Sep. 13, 2022

(51) Int. Cl. G06F 1/16; G06F 3/0354

(52) U.S. Cl. CPC G06F 1/1607; G06F 3/03545

(57) ABSTRACT

Examples of an input device holder assembly are described herein. In one example, the input device holder assembly can include a first holding element and a second holding element to cooperate with the first holding element to hold a writing instrument. The first holding element includes a first receptacle channel and the second holding element includes a second receptacle channel. Both, the first and the second receptacle channels are formed as open-ended slots. The first holding element and the second holding element are positioned relative to each other to align the first receptacle channel and the second receptacle channel to receive and remove the writing instrument.

### BACKGROUND

Portable computing devices, such as tablet personal computers (tablet PCs) and laptop PCs, have become ubiquitous in use. Few of such computing devices may use, as an input device, a pen or a stylus, generally, referred to as a writing instrument. For instance, the writing instrument can allow a user of the computing device to interface with the computing device in a convenient manner, as if the user is using an ink-based writing instrument.

### BRIEF DESCRIPTION OF FIGURES

The detailed description is provided with reference to the accompanying figures, wherein:

FIG. 1 illustrates a schematic of an input device holder assembly, according to an example;

FIG. 2 illustrates a schematic of a computing device employing the input device holder assembly, according to another example;

FIG. 3 illustrates a schematic of the computing device employing the input device holder assembly, in accordance with another example;

FIG. 4A, FIG. 4B, FIG. 4C, and FIG. 4D illustrate various views of the computing device 200, according to an example;

FIG. 5A and FIG. 5B illustrate a holding element of the input device holder assembly according to an example;

FIG. 6A, FIG. 6B, FIG. 6C, and FIG. 6D illustrate various examples of the computing device having the input device holder assembly.

It should be noted that the description and the figures are merely examples of the present subject matter and are not meant to represent the subject matter itself. Throughout the drawings, identical reference numbers designate similar, but not identical, elements. The figures are not to scale, and the size of some parts may be exaggerated to more clearly illustrate the example shown. Moreover, the drawings provide examples and/or examples consistent with the description; however, the description is not limited to the examples and/or examples provided in the drawings.

### DETAILED DESCRIPTION

Few of such computing devices may use, as an input device, a pen or a stylus, generally, referred to as a writing instrument. For instance, the writing instrument can allow a user of the computing device to interface with the computing device in a convenient manner, as if the user is using an ink-based writing instrument. At the same time, such computing devices provide a mechanism for mounting the writing instrument to the computing device itself for the convenience of the user. For example, one of the more widely used mounting technique employs a magnet provided on a side surface of the computing device, and the writing instrument either has a magnetic body or has a complementary magnet which can cooperate with the magnet on the side surface of the computing device so that the writing instrument can be easily and effortlessly attached to and detached from the computing device.

Examples of an input device holder assembly for cooperating, for instance, holding and removing, a writing instrument, usable with a computing device are provided herein. According to an aspect, the input device holder assembly is designed in a manner that the writing instrument is, firstly, held with adequate force so that the writing instrument does not inadvertently detach from the input device holder assembly. Secondly, the input device holder assembly is so designed that a longitudinal slot is formed which is open ended at both its ends. As a result, the writing instrument can be inserted and/or removed from the longitudinal slot along the slot from either of the open ends of the longitudinal slot.

According to one example, the input device holder assembly includes a first holding element and a second holding element to cooperate with the first holding element to hold the writing instrument. The first holding element has a first receptacle channel and the second holding element has a second receptacle channel, respectively. The receptacle channels are each formed as an open-ended slot extending in a longitudinal direction and the first holding element and the second holding element are positioned relative to each other to align the first receptacle channel and the second receptacle channel. Accordingly, the two receptacle channels together, when positioned in such manner, form between them a slotting structure which is open in two directions, i.e., at both the longitudinal ends of the open-ended slots. With such a design of the input device holder assembly, the writing instrument can be received into and removed from the two receptacle channels along a longitudinal direction of the receptacle channels. Since the slotting structure formed between the two receptacle channels is open at the two longitudinal ends, the writing instrument can be removed or inserted into the slotting structure in two directions.

In addition, with such a design, the input device holder assembly may be accommodated with any type or design of the computing device and may not involve any modification in the computing device. For example, the input device holder assembly can be used with a laptop having a clamshell design as much as it can be used with a hybrid or 2-in-1 convertible laptop or a laptop having a 360 degrees screen-rotation. At the same time, the input device holder assembly can also be used with tablet computers or mobile phones. In any of these applications, the computing device can use the input device holder assembly without any modification and the input device holder assembly, owing to insertion and removal of the writing instrument along two directions, can be adapted to be used with any computing device.

The above aspects are further described in conjunction with the figures, and in associated description below. It should be noted that the description and figures merely illustrate principles of the present subject matter. Therefore, various arrangements that encompass the principles of the present subject matter, although not explicitly described or shown herein, may be devised from the description and are included within its scope. Additionally, the word “coupled” is used throughout for clarity of the description and can include either a direct connection or an indirect connection.

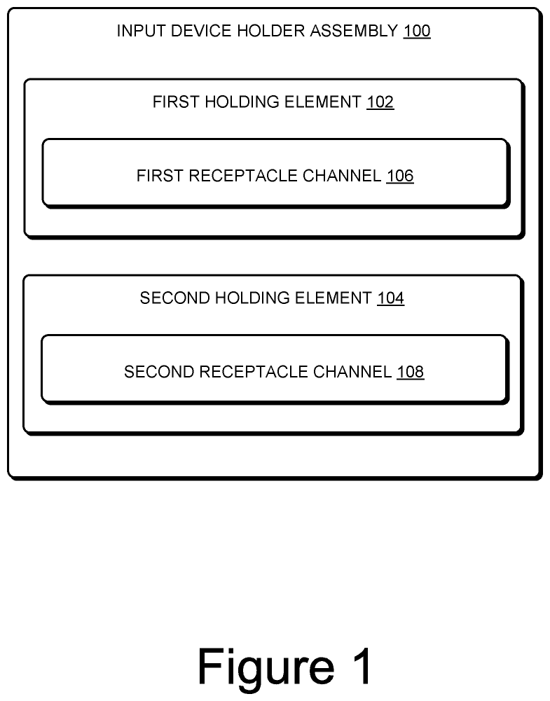

FIG. 1 illustrates a schematic of an input device holder assembly 100, for instance, for a computing device (not shown) for holding a writing instrument (not shown) usable with the computing device, in accordance with an example of the present subject matter. The writing instrument, in an example, can be a stylus or a pen, that can be used as an input device for the computing device using which a user can interface with the computing device. In an example, in case that the computing device is a tablet PC or mobile phone having a book-style protective case, the input device holder assembly 100 can be designed to be disposed at a junction between the two flaps of the book-style protective case of the computing device.

According to the present example, the input device holder assembly 100 can include a first holding element 102 and a second holding element 104 to cooperate with the first holding element 102 to hold the writing instrument. The first holding element 102 can include a first receptacle channel 106 and the second holding element 104 can, similarly, includes a second receptacle channel 108. As an aspect, the input device holder assembly 102 can be designed in such a manner that the first receptacle channel 104 and the second receptacle channel 108, together, form an open-ended longitudinal slot in which the writing instrument can be inserted and removed in two directions. Accordingly, the first receptacle channel 106 and the second receptacle channel 108 are both formed as an open-ended slot extending in a longitudinal direction, i.e., along a direction in which the writing instrument is to be inserted or removed. Further, the first holding element 102 and the second holding element 104 are positioned relative to each other to align the first receptacle channel 106 and the second receptacle channel 108, for instance, to cooperate and form the longitudinal slot, to receive and remove the writing instrument along the longitudinal direction of the first receptacle channel 106 and the second receptacle channel 108.

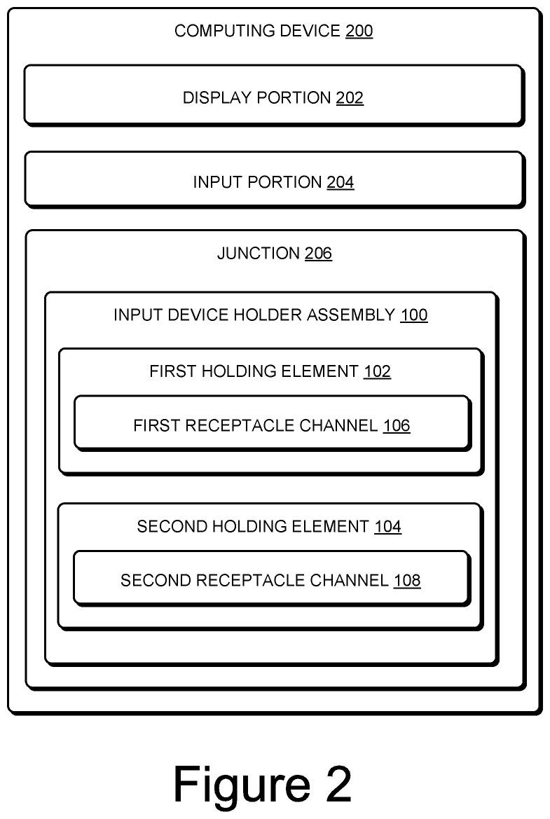

FIG. 2 illustrates a schematic of a computing device 200, for instance, which can employ the input device holder assembly 100, according to an example of the present subject matter. As an example, the computing device 200 can be, for example, a laptop personal computer (PC), a desktop PC, a notebook PC, a mobile phone, a tablet PC, or a personal digital assistant (PDA). For instance, the computing device 200 can be one of a clamshell-type device, a 2-in-1 convertible-type device, a tablet-type device, a mobile phone, and a clamshell-type device having a 360 degrees screen-rotation.

In the present example, the computing device 200 can include a display portion 202 and an input portion 204 coupled to the display portion 202, for instance, swivelable with respect to the display portion 202. For instance, the display portion 202 can be body portion having a screen or display of the computing device 200 and the input portion 204 can be a body portion having a keyboard or a trackpad or a combination thereof, and the display portion 202 and the input portion 204 can be coupled, detachably or otherwise, to each other. The computing device 200 can further include the input device holder assembly 100 to hold the writing instrument usable with the computing device 200. According to an aspect, the input device holder assembly 100 can be disposed at a junction 206 between the display portion 202 and the input portion 204. For instance, in case of the 2-in-1 convertible-type device having a screen which can be detached from its keyboard, or in case of the clamshell-type device, the input device holder assembly can be provided at an edge of the screen or the keyboard, where the keyboard and the screen are hinged together.

As explained above, the input device holder assembly 100 can include the first holding element 102 and the second holding element 104 to cooperate with the first holding element 102 to hold the writing instrument. The first holding element 102 can include the first receptacle channel 106 and the second holding element 104 can, similarly, includes the second receptacle channel 108 extending in a direction as the first receptacle channel 106 extends. The first receptacle channel 106 and the second receptacle channel 108 are both formed as the open-ended slot extending in the same direction, i.e., along the direction in which the writing instrument is to be inserted or removed. Further, the first receptacle channel 106 of the first holding element 102 faces the second receptacle channel 108, such that the writing instrument can be inserted into and removed from the first holding element 102 and the second holding element 104 along the directions of the first receptacle channel 106 and the second receptacle channel 108, i.e., along the two directions in which the open ends of the first receptacle channel 106 and the second receptacle channel 108 are disposed.

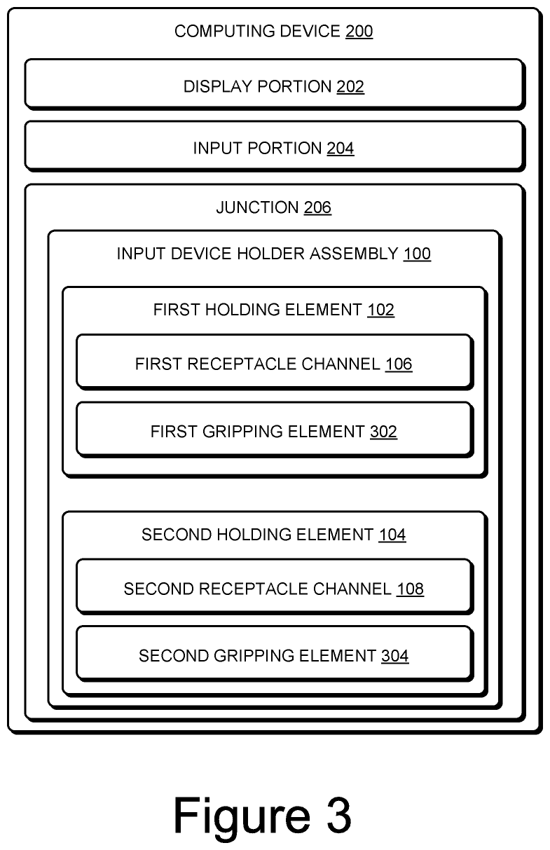

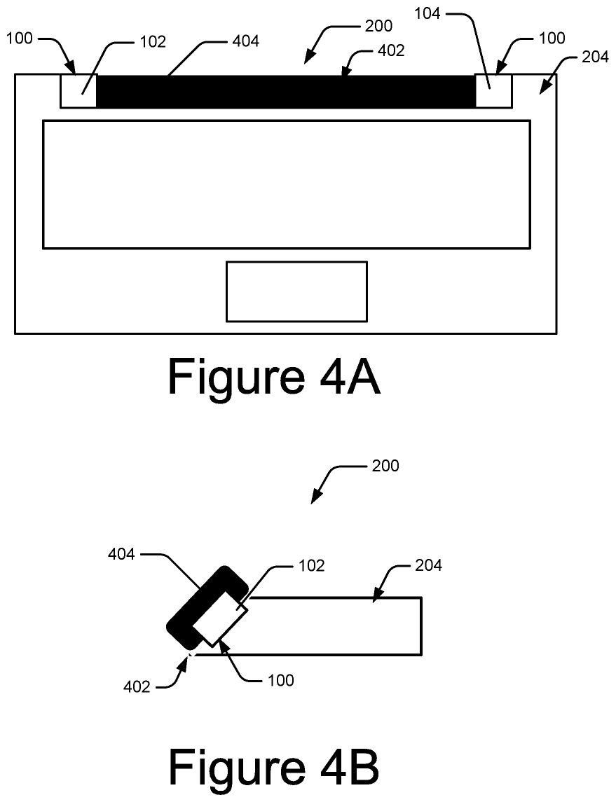

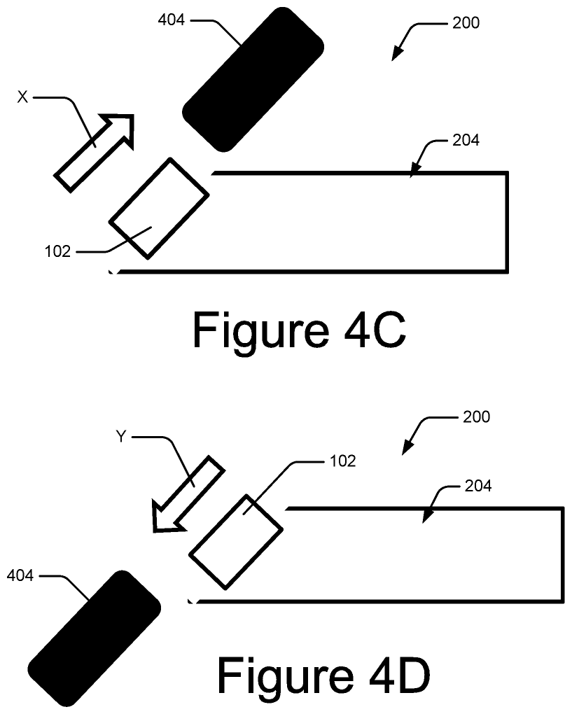

FIG. 3 illustrates a schematic of the computing device 200, according to another example of the present subject matter. In the present example, in addition to that described in reference to FIG. 2, the first holding element 102 of the input device holder assembly 100, disposed at one end of the junction 206, includes a first gripping element 302 to clasp a first end of the writing instrument. Similarly, the second holding element 104, disposed at another end of the junction 206, includes a second gripping element 304 to clasp a second end of the writing instrument. As mentioned before, the first gripping element 302 and the second gripping element 304, in addition to the first receptacle channel 106 and the second receptacle channel 108 cooperating with each other, also cooperate with each other to hold the writing instrument when inserted into the longitudinal slot formed between the first receptacle channel 106 and the second receptacle channel 108. The input device holder assembly 100 and the computing device 200 are described in detail with reference to FIG. 4A to FIG. 6D.

FIG. 4A and FIG. 4B illustrate the computing device 200 having the input device holder assembly 100, according to an example of the present subject matter. While FIG. 4A illustrates a front view of the computing device 200 showing the input portion 204 thereof, FIG. 4B illustrates a side sectional view of the computing device 204 where the display portion 202 thereof is not shown. For the sake of brevity and easy of understanding, FIG. 4A and FIG. 4B, are discussed in conjunction hereinafter. In the present example, as explained earlier, the input device holder assembly 100 is provided at a junction 206 of the input portion 204, represented by an edge 402 of the input portion 204. In another example, however, the input device holder assembly 100 can be provided at an edge (not shown) of the display portion 202 of the computing device 100.

Further, the first holding element 102 and the second holding element 104 of the input device holder assembly 100 are disposed along the edge 402, for instance, displaced from each other at a distance at least a length of the writing instrument 404. As has been explained earlier, the first holding element 102 and the second holding element 104 cooperate to form the longitudinal slot which can extend along a direction which is substantially orthogonal to the edge 402. In one example, the first holding element 102 and the second holding element 104 can be aligned with each other in a manner that the first receptacle channel 106 is substantially parallel to, substantially aligned with, and facing the second receptacle channel 108. Accordingly, the writing instrument 404 can be inserted into or withdrawn from the input device holder assembly 100 in two directions along the longitudinal slot. In other words, the writing instrument 404 can be inserted into or withdrawn from the input device holder assembly 100 towards the edge 402 or away from the edge 402. The directions of insertion X and withdrawal Y of the writing instrument 404 into and from the input device holder assembly 404 is illustrated by arrows X and Y in FIGS. 4C and 4D.

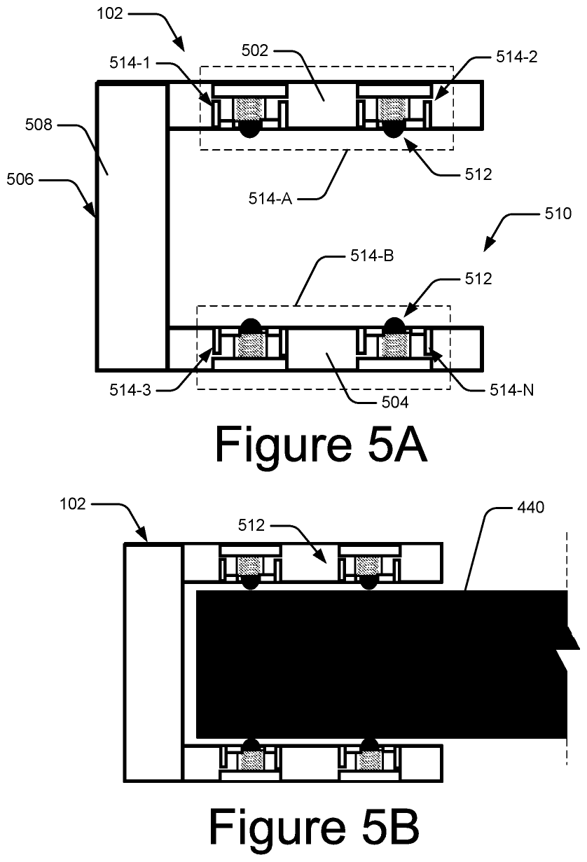

FIG. 5A and FIG. 5B illustrate a sectional front view of a holding element, such as the first holding element 102. FIG. 5A illustrates the first holding element 102 whereas FIG. 5B illustrates the first holding element 102 holding an end of the writing instrument 404. The same description also serves for the second holding element 104 and, for the sake of brevity, the second holding element 104 is not described separately. In addition, for the sake of brevity and ease of understanding, FIG. 5A and FIG. 5B are discussed in conjunction hereinafter.

As explained previously, the first holding element 102 has the first receptacle channel 106 formed as the open-ended slot extending in a longitudinal direction, for instance, along a direction of a direction of viewing. In other words, the first receptacle channel 106 is open at the two ends of the longitudinal slot for the insertion and removal of the writing instrument 404 therefrom, as is evident from FIGS. 4C and 4D. Further, in an example, the first receptacle channel 106 can be formed between two opposing walls 502 and 504 which are joined at, a distal end 506, by a connecting element 508. For instance, the connecting element 508 may also be a wall that extends for the length of the first receptacle channel 106. A proximal end 510 of the first receptacle channel 106 can face a proximal end (not shown) of the second receptacle channel 108, in input device holder assembly 100, to collectively form the longitudinal slot for the writing instrument 404.

In an example of the present subject matter, the first receptacle channel 106 can include a first gripping element 512 to clasp a first end of the writing instrument 404. In one case, the first gripping element 512 can include a spring-loaded clasp (not shown) at each of the two opposing walls 502 and 504 of the first receptacle channel. In such a case, the spring-loaded clasps can be disposed on the two opposing walls to be substantially aligned with each other, for instance, their clasping portions being parallel to each, so that the two spring loaded clasps can adequately hold the writing instrument 404.

In another case, the first gripping element 512 can include a plurality of spring-loaded balls 514-1, 514-2 . . . 514-N, collectively referred to as spring loaded balls 514 and individually referred to as spring loaded ball 514. The spring-loaded balls 514 can be provided in two sets, a first set 514-A and a second set 514-B, which can be disposed at each of the two opposing walls 502 and 504, for instance, to operate as the spring-loaded clasps for holding the writing instrument 404. The first set 514-A of the spring-loaded balls 514 can be disposed along the longitudinal direction, for instance, in the direction in which the first receptacle channel 106 extends, on one of the opposing walls 502. Similarly, the second set 514-B of the spring-loaded balls 514 can be disposed along the same longitudinal direction on other wall 504, and the first set 514-A and the second set 514-B can be aligned with respect to each other. In one example, each set 514-A and 514-B can include two spring-loaded balls 514 which can be staggered with respect to each other in the longitudinal direction. In another example, each set 514-A and 514-B can include four spring-loaded balls 514 which can be staggered with respect to each other in the longitudinal direction as well as in a direction perpendicular to the longitudinal direction, such that they are able to adequately hold the writing instrument 404. Accordingly, in other examples, the first set 514-A and the second set 514-B can include any number of spring-loaded balls 514 which can suffice for adequately holding the writing instrument 404.

Similarly, for the second receptacle channel 108, in an example of the present subject matter, the second receptacle channel 108 can include a second gripping element (not shown) to clasp a first end of the writing instrument 404. In one case, the second gripping element (not shown) can include a spring-loaded clasp (not shown) at each of the two opposing walls and of the first receptacle channel. In such a case, the spring-loaded clasps can be disposed on the two opposing walls to be substantially aligned with each other, for instance, their clasping portions being parallel to each, so that the two spring loaded clasps can adequately hold the writing instrument 404.

In another case, the second gripping element (not shown) can include a plurality of spring-loaded balls, collectively referred to as spring loaded balls (not shown) and individually referred to as spring loaded ball. The spring-loaded balls (not shown) can be provided in two sets, a first set and a second set, which can be disposed at each of the two opposing walls, for instance, to operate as the spring-loaded clasps for holding the writing instrument 404. The first set of the spring-loaded balls (not shown) can be disposed along the longitudinal direction, for instance, in the direction in which the second receptacle channel 108 extends, on one of the opposing walls. Similarly, the second set of the spring-loaded balls (not shown) can be disposed along the same longitudinal direction on other wall, and the first set and the second set can be aligned with respect to each other. In one example, each set and can include two spring-loaded balls (not shown) which can be staggered with respect to each other in the longitudinal direction. In another example, each set and can include four spring-loaded balls (not shown) which can be staggered with respect to each other in the longitudinal direction as well as in a direction perpendicular to the longitudinal direction, such that they are able to adequately hold the writing instrument 404. Accordingly, in other examples, the first set and the second set can include any number of spring-loaded balls (not shown) which can suffice for adequately holding the writing instrument 404.

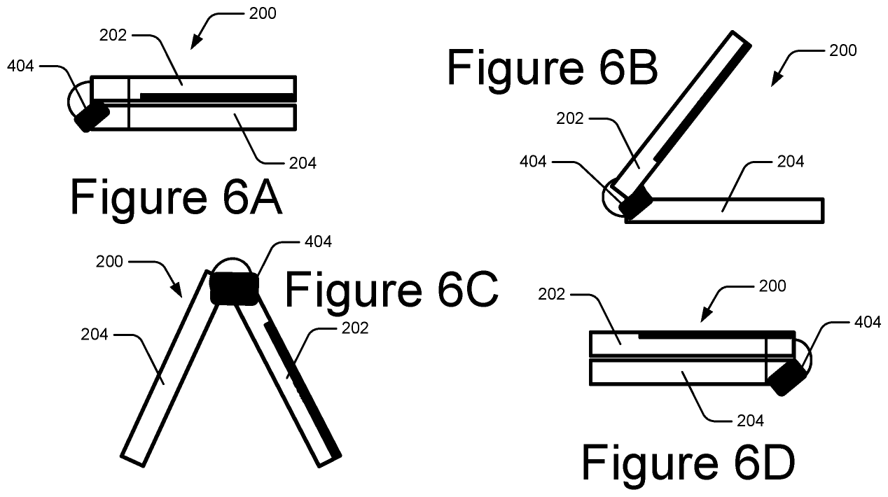

FIG. 6A, FIG. 6B, FIG. 6C, and FIG. 6D illustrate various examples of the computing device 200 having the input device holder assembly 100. For instance, FIG. 6A illustrates the computing device 200 being a clamshell-type device or a 2-in-1 convertible-type device in which the computing device 200 is in a closed state, for example, switched off or in a sleep mode, and the display portion 202 and the input portion 204 abut against each other. In such a state, as seen in FIG. 6A, the input device holder assembly 100 can be adequately used to insert or remove the writing instrument 404 in one direction, from where the longitudinal slot in the input device holder assembly 100 formed by the first receptacle channel 106 and the second receptacle channel 108 remains open. For example, in the present case, the longitudinal slot can remain open in a direction away from a user of the computing device 200.

In another instance, illustrated in FIG. 6B, in which the computing device 200 is being used in a clamshell-state or a laptop state, the input device holder assembly 100, by virtue of its design as discussed earlier, can be used to receive or withdraw the writing instrument 404 in two directions, i.e., from both the open ends of the longitudinal slot formed by the first receptacle channel 106 and the second receptacle channel 108. Further, in case the computing device 200 can have a 360 degrees screen rotation, the computing device 200 may be usable in a tent mode, as shown in FIG. 6C, where the writing instrument 404 can, again, be inserted or removed in two directions.

In addition, as shown in FIG. 6D, when such a computing device 200 is used in a tablet mode, in which the display portion 202 and the input portion 204 can abut each other at their rear surfaces, even then the input device holder assembly 100 can be adequately used to insert or remove the writing instrument 404 in one direction in which longitudinal slot is open, i.e., facing the user of the computing device 200. Therefore, with such a design, the input device holder assembly 100 may be used with any type or design of the computing device 100 and may not involve any modification in the computing device 100, while at the same time providing adequate access to the writing instrument 404 to the user. Accordingly, whether computing device 200 is a laptop having a clamshell design, a laptop with a hybrid 2-in-1 convertible-design, a laptop having a 360 degrees screen-rotation, a tablet PC, or a mobile phone, the input device holder assembly 100 can be used with the computing device 200 irrespective of the design of the computing device 200.

Although aspects of the input device holder assembly 100 and the computing device 200 have been described in a language specific to structural features and/or methods, it is to be understood that the subject matter is not limited to the features or methods described. Rather, the features and methods are disclosed as examples of the input device holder assembly 100 and the computing device 200.

I/We claim:

1. An input device holder assembly comprising:
a first holding element; and
a second holding element to cooperate with the first holding element to hold a writing instrument for use with a computing device;
the first holding element comprising a first receptacle channel and the second holding element comprising a second receptacle channel, wherein each of the first receptacle channel and the second receptacle channel is formed as an open-ended slot extending in a longitudinal direction; and
wherein the first holding element and the second holding element are positioned relative to each other to align the first receptacle channel and the second receptacle channel to receive and remove the writing instrument along the longitudinal direction of the first receptacle channel and the second receptacle channel.

2. The input device holder assembly as claimed in claim 1, wherein the first receptacle channel comprises a first gripping element to clasp a first end of the writing instrument.

3. The input device holder assembly as claimed in claim 2, wherein the first gripping element comprises a spring-loaded clasp at each of two opposing walls of the first receptacle channel.

4. The input device holder assembly as claimed in claim 2, wherein the first gripping element comprises a plurality of spring-loaded balls disposed at each of two opposing walls of the first receptacle channel, wherein a first set of the plurality of spring-loaded balls is disposed along the longitudinal direction on one wall of the two opposing walls and a second set of the plurality of spring-loaded balls is disposed along the longitudinal direction on other wall of the two opposing walls, the first set and the second set being aligned with respect to each other.

5. The input device holder assembly as claimed in claim 1, wherein the second receptacle channel comprises a second gripping element to clasp a second end of the writing instrument.

6. The input device holder assembly as claimed in claim 5, wherein the second gripping element comprises a spring-loaded clasp disposed at each of two opposing walls of the second receptacle channel.

7. The input device holder assembly as claimed in claim 5, wherein the second gripping element comprises a plurality of spring-loaded balls disposed at each of two opposing walls of the second receptacle channel, wherein a first set of the plurality of spring-loaded balls is disposed along the longitudinal direction on one wall of the two opposing walls and a second set of the plurality of spring-loaded balls is disposed along the longitudinal direction on other wall of the two opposing walls, the first set and the second set being aligned with respect to each other.

8. A computing device comprising:
a display portion;
an input portion coupled to the display portion; and
an input device holder assembly to hold a writing instrument usable with the computing device, wherein the input device holder assembly is disposed at a junction between the display portion and the input portion, the input device holder assembly comprising:
a first holding element having a first receptacle channel being open-ended and extending in a direction substantially perpendicular to the junction between the display portion and the input portion; and
a second holding element having a second receptacle channel being open-ended and extending in a direction as the first receptacle channel extends;
wherein the first receptacle of the first holding element faces the second receptacle of the second holding element, the writing instrument being insertable into and removable from the first holding element and the second holding element in the direction as the first receptacle channel and the second receptacle channel extends.

9. The computing device as claimed in claim 8, wherein the first receptacle channel and the second receptacle channel comprise a first gripping element and a second gripping element, respectively, to clasp the writing instrument.

10. The computing device as claimed in claim 9, wherein the first gripping element and the second gripping element each comprises a spring-loaded clasp disposed at each of two opposing walls of the first receptacle channel and the second receptacle channel, respectively.

11. The computing device as claimed in claim 9, wherein the first gripping element and the second gripping element each comprises a plurality of spring-loaded balls disposed at each of two opposing walls of the second receptacle channel, wherein a first set of the plurality of spring-loaded balls is disposed along the longitudinal direction on one wall of the two opposing walls and a second set of the plurality of spring-loaded balls is disposed along the longitudinal direction on other wall of the two opposing walls, the first set and the second set being aligned with respect to each other.

12. The computing device as claimed in claim 8, wherein the computing device is one of a clamshell-type device, a 2-in-1 convertible-type device, a tablet-type device, a mobile phone, and a clamshell-type device having a 360 degrees screen-rotation.

13. A computing device comprising:
a display portion;
an input portion hinged to the display portion; and
an input device holder assembly to hold a writing instrument usable with the computing device, wherein the input device holder assembly is disposed at a junction between the display portion and the input portion, the input device holder assembly comprising:
a first holding element disposed at one end of the junction between the display portion and the input portion, the first holding element having:
a first receptacle channel formed as an open-ended slot to receive a first end of the writing instrument; and
a first gripping element to clasp the first end of the writing instrument; and
a second holding element disposed at another end of the junction between the display portion and the input portion, the second holding element having:
a second receptacle channel formed as an open-ended slot to receive a second end of the writing instrument, wherein the second receptacle channel faces the first receptacle channel; and
a second gripping element to clasp the second end of the writing instrument.

14. The computing device as claimed in claim 13, wherein the first gripping element and the second gripping element each comprises a spring-loaded clasp disposed at each of two opposing walls of the first receptacle channel and the second receptacle channel, respectively.

15. The computing device as claimed in claim 13, wherein the computing device is one of a clamshell-type device, a 2-in-1 convertible-type device, and a clamshell-type device having a 360 degrees screen-rotation.
